(19) United States
(12) Patent Application Publication
(10) Pub. No.: US 2021/0090477 A1
(43) Pub. Date: Mar. 25, 2021

(54) Forget Me Knot

(71) Applicant: Stephanie Ann Green, Milwaukie, OR (US)

(72) Inventor: Stephanie Ann Green, Milwaukie, OR (US)

(21) Appl. No.: 16/578,327

(22) Filed: Sep. 21, 2019

(51) Int. Cl. G09F 21/04

(52) U.S. Cl. CPC G09F 21/04

(57) ABSTRACT

The purpose of this patent application is to obtain a patent on the Forget Me Knot. The main purpose for this invention is to benefit caretakers in terms of helping to eliminate babies being left in the back of the car. When the driver or passenger opens the car door, a sign that is on fabric or material is spread open (the sign is attached to the driver side door and the other side is attached to the driver side area) and when the door opens the sign or message is displayed,

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. This invention does not improve any other product on the market. It is a new product and that is standalone. The main impetus for the Forget Me Knot is to create a visual reminder to not forget the child in the back of the car by a sign that indicates a child is in the back and to look back there. The sign is simple in nature and is attached from the driver side door to the driver's area of the car. Again, one side of the sign is attached to the driver's side door and the other part of the sign is attached to the driver's area of the car. When the car door is opened, the sign is extended from the car door to the main driver's area of the car. The sign has verbiage that reminds the driver to look in the back of the car as there is a baby or child back there. No specific verbiage and all language to indicate a baby or child is in the back is in scope.

Stephanie Ann Green is a full-time working mother of 3 small kids with an MBA. Her house is comprised of 3 small children and she reads horrifying stories about, children being left in the back of a hot car. Most folks are also not that technical and most of the “child in back” monitoring systems are technical, complex and expensive. Sleep deprivation does not lend itself to being technically on the mark and savvy when in a haze and fog. Therefore, it is imperative to have a low-tech way to signal and remind drivers that a baby is in back or a child is in back. Out of the necessity of being a paranoid mother, the Forget Me Knot was invented. The Forget Me Knot is more than a sign; it is also a Knot that will represent to look in back of a car. Welcome; the “Forget Me Knot”.

### BRIEF SUMMARY OF THE INVENTION

As mentioned above, there is a huge market and need for this product. There are no low technical reminder systems that a baby is in back of the car. Most are too tired to remember to setup a system or to take time to set the reminder. It is it too technical, most people will not use it. Think about grandparents taking their grandchildren to daycare, or a super sleep deprived mother or father. That is why the Forget Me Knot was created. It is a simple visual notification to signal to the driver to look in the back of the car as there may be a child or baby in the back.

### BRIEF DESCRIPTION OF THE SEVERAL VIEWS OF THE DRAWING

Please refer to separate diagram of the Forget Me Knot. Each element is properly labeled.

### DETAILED DESCRIPTION OF THE INVENTION

There is no other invention like this on the market. This is not an improved product patent either. The process is simple with existing materials on the market. All materials are on the market currently so it's a matter of assembling existing materials that are commercially available. This invention requires the use of a magnets, snaps, velcro, fabric and a written message to signify a baby or child is in the hack of the car. No special tooling is required. Very simple manufacturing process.

### Drawings

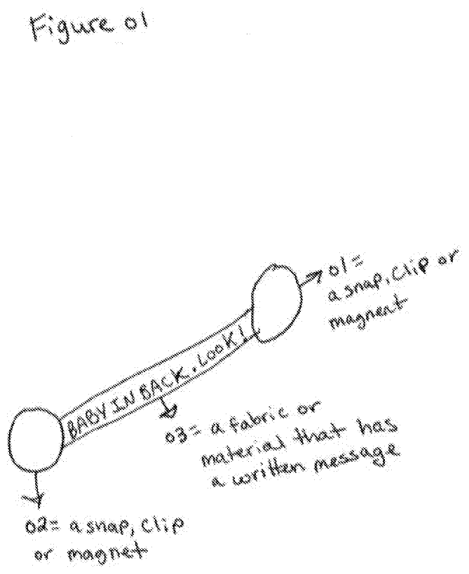

A sketch is attached as a separate drawing as FIG. 1 which is the top view.

Each item that is included in the drawing is labeled as follows:

1=A snap, dip, magnet or similar that is attached to one side of the sign.

2=A snap, clip, magnet or similar that is attached to the other side of the sign.

3=Any material or fabric that is used to display the written message to look in the back as a baby is onboard. Any similar verbiage is in scope.

1. A sign or notification system that reminds the car's driver or passenger that a baby or child is in back and to look in the back.
(a) A sign or message like; “look in the back of the car” that is displayed when the car door is open.
(b) A baby in back of car indicator system that is attached to the driver's side area of the car to the driver's side door (passenger side is in scope as well).
(c) The sign or message that is extended from the car door to the driver/passenger side area to warn the driver or passenger that a baby is in the back and to look.
